(19) United States
(12) Patent Application Publication
(10) Pub. No.: US 2019/0042339 A1
(43) Pub. Date: Feb. 7, 2019

(54) TECHNIQUES FOR INVOCATION OF A FUNCTION OR A SERVICE

(71) Applicant: Intel Corporation, Santa Clara, CA (US)

(72) Inventors: Kshitij A. DOSHI, Tempe, AZ (US); Vadim SUKHOMLINOV, Santa Clara, CA (US)

(21) Appl. No.: 16/024,614

(22) Filed: Jun. 29, 2018

(51) Int. Cl. G06F 9/54; G06F 9/455

(52) U.S. Cl. CPC G06F 9/547; G06F 2009/45595; G06F 9/45558

(57) ABSTRACT

Examples include techniques for invocation of a function or service. Examples include receiving a call instruction from an application hosted by a platform to invoke a virtual function provided by a different application. Information included in the call instruction are used to determine how to prepare for and enter an invocation of the call for the virtual function.

### TECHNICAL FIELD

Examples described herein are generally related to invocation of a function or a service by an application across a network.

### BACKGROUND

A relatively new technology referred to as network function virtualization (NFV) is rapidly evolving over recent years. In some examples, NFV infrastructure is becoming increasingly important to large data centers, cloud computing centers or telecommunication providers to allow for a pooling of at least some computing resources that may be disaggregated and/or located in diverse geographic locations. In an example virtualized environment for NFV infrastructure, multiple virtual machines (VMs) may be hosted by a host computing system. The multiple VMs may separately execute one or more virtual network functions (VNFs) or applications associated with the one or more VNFs. A given VNF executed by one or more VMs may fulfill a function that may have been previously implemented using dedicated hardware devices (e.g., firewalling, network address translation, etc.). Also, virtualized network environments are also able to provide a variety of new applications to the end users. For example, deployments where single computing applications are packaged into special purpose virtual computing nodes (e.g., containers and VMs) are gaining widespread acceptance with the maturing of Docker® and other similar virtualization technologies.

### BRIEF DESCRIPTION OF THE DRAWINGS

FIG. 1 illustrates an example first system.

FIG. 2 illustrates an example second system.

FIG. 3 illustrates an example third system.

FIG. 4 illustrates an example process.

FIG. 5 illustrates example structures for use in invocation of a function or service.

FIG. 6 illustrates an example tables for invocation of a function or service.

FIG. 7 illustrates an example flow for invocation of a function or service.

FIG. 8 illustrates an example block diagram for an apparatus.

FIG. 9 illustrates an example of a logic flow.

FIG. 10 illustrates an example of a storage medium.

### DETAILED DESCRIPTION

In an example contemporary data center, functions previously performed by a dedicated logic element and/or hardware in an NFV context may be thought of in terms of a logical or virtual function or service. For example, in the NFV and/or cloud context a logical or virtual function or service may include deep packet inspection (DPI). Other logical or virtual functions may include, but are not limited to, logical or virtual functions of data encryption, data decryption, data compression, data decompression, internet protocol (IP) security, accounting functions, or performance trackers.

According to some examples, the NFV context may support an Everything as a Function or Function as a Service (FaaS) paradigm/model that may evolve from an Everything as a Service (XaaS) model. The evolution of an FaaS model is about being able to call up reusable, fine-grained software components across a network and may include other models such as Infrastructure as a Service (IaaS) models, Platform as a Service (PaaS) models, or Software as a Service (SaaS) models. An FaaS model may be well suited for cases when, to a software application, there is no difference between (a) calling another function executed by an application, (b) making a system call, (c) invoking a hardware accelerator functionality, or (d) issuing a remote call to a cloud service. Efficient implementation of an FaaS model may require unified and efficient mechanisms to allow applications to call or make invocations of functions agnostic to the applications specific implementations. An application's ability to call or make invocations of functions in way that is agnostic to specific implementations may allow for hardware acceleration for calls or invocations that may have not been previously possible due to legacy software design patterns.

A type of cross domain control transfer common in distributed applications and services is referred to as a remote procedure call (RPC). RPC typically has high costs (e.g., measured in processing cycles and/or latency) that may be attributable to associated context-switches, cross-stack copying (under control of a supervisor/hypervisor), and secure control transfers. RPCs have been an important mechanism for building client-server or peer-to-peer interactions to call or invoke functions. Efficient calling or invoking of virtual functions (e.g., via use of RPCs) may pose a significant problem when implementing FaaS models. Difficulties associated with efficient calling or invoking of virtual functions when implementing FaaS models will likely grow when issues such as efficient isolation through lighter-weight containment and/or service level agreement (SLA) support may also need to be addressed.

In an example RPC interaction for a current FaaS model implementation, a caller (e.g., an application wanting to invoke a function) may have to (a) move from its data from user space into kernel, where, (b) after validation of various capabilities (c) the call parameters/data are marshalled and (d) messaged over a right or given transport mechanism to the caller (e.g., the resource supporting the virtual function invoked). While the interaction involved in steps (a)-(d) above may consist of routine (cookie-cutter) actions, their boiler-plate code sequences may have to be performed across different domains which typically requires supervisory intervention. The need for supervisory intervention may become expensive in turns of system processing cycles and/or other computing resources consumed. Similar overheads apply on the callee's/invoked virtual function side. Similar overheads may come into play on a return path between the callee and the caller. As hardware components in computing systems implementing FaaS models become computationally faster in successive hardware technology generations these overheads become an ever increasing portion of total costs associated with implementing FaaS models. It is with respect to these challenges that the examples described herein are needed.

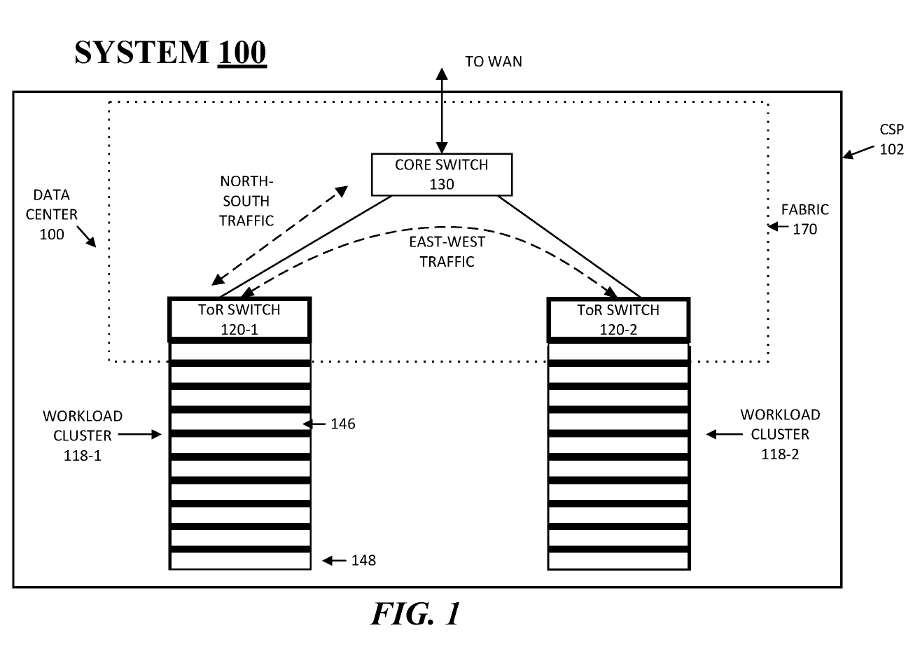

FIG. 1 illustrates an example system 100. In some examples, system 100 may represent a network-level diagram of a cloud service provider (CSP) 102. CSP 102 may be, but is not limited to, a traditional enterprise data center, an enterprise “private cloud,” or a “public cloud,” providing services using models or combinations of models that include, but are not limited to, FaaS, IaaS models, PaaS models, or SaaS models.

In some examples, CSP 102 may provision some number of workload clusters 118, which may be clusters of individual servers, blade servers, rackmount servers, or any other suitable server topology. For these examples, two workload clusters, 118-1 and 118-2 are shown, that are supported by rack mountable servers 146 in a chassis 148.

According to some examples, each server 146 may host a standalone operating system and provide a server function, or servers may be virtualized, in which case they may be under the control of a virtual machine manager (VMM), hypervisor, and/or orchestrator (not shown), and may host one or more virtual machines, virtual servers, or functions (also not shown). These server racks may be collocated in a single data center or may be located in different geographic data centers. In some examples, depending on contractual agreements, some servers 146 may be specifically dedicated to certain enterprise clients or tenants, while others may be shared.

According to some examples, a virtual machine is a software computer that, like a physical computer, runs an operating system and applications. The virtual machine is comprised of a set of specification and configuration files and is backed by the physical resources of a host. Also, a hypervisor or VMM is computer software, firmware or hardware that creates and runs virtual machines. A computer on which a hypervisor runs one or more virtual machines is called a host machine, and each virtual machine is called a guest machine. The hypervisor or VMM presents the guest operating systems with a virtual operating platform and manages the execution of the guest operating systems. Multiple instances of a variety of operating systems may share the virtualized hardware resources: for example, Linux, Windows, and macOS instances can all run on a single physical processor with multiple cores. This contrasts with operating-system-level virtualization, where all instances (usually called containers) must share a single kernel, though the guest operating systems can differ in user space, such as different Linux distributions with the same kernel.

In some examples, various devices of data center 100 may be connected to each other via a fabric 170. Fabric 170 may include one or more high speed routing and/or switching devices and may provide both “north-south” data traffic (e.g., traffic to and from the wide area network (WAN), such as the internet), and “east-west” data traffic (e.g., traffic across the data center). Historically, north-south traffic accounted for the bulk of network data traffic, but as web services or functions associated with FaaS models become more complex and distributed, the proportional volume of east-west data traffic compared to north-south data traffic may continue to increase. In some data centers, east-west data traffic may now account for a majority of data traffic.

According to some examples, as capabilities of each server 146 increases, data traffic volume may further increase. For example, each server 146 may provide multiple processor slots, with each slot accommodating a processor having four, eight, sixteen, etc. cores, along with sufficient memory to support processing operations for the cores. As a result, each server may be capable of hosting an increasing number of VMs or containers, each generating its own data traffic.

In some examples, to accommodate the large volume of a traffic in a data center, a highly capable fabric 170 may be provided. For this example, fabric 170 may be a “flat” network, where each server 146 may have a direct connection to a top-of-rack (ToR) switch 120 (e.g., a “star” configuration), and each ToR switch 120 may couple to a core switch 130. This example two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

According to some examples, fabric 170 may provide any suitable interconnect. For example, each server 146 may include a fabric interface, such as an Intel® Host Fabric Interface (HFI), a network interface card (NIC), or other type of host interface to couple with fabric 170. The host interface itself may couple to one or more processors via an interconnect or bus, such as PCI, PCIe, or similar, and in some cases, this interconnect bus may be considered to be part of fabric 170.

The interconnect technology may be provided by a single interconnect or a hybrid interconnect, such where PCIe provides on-chip communication, 1 Gb or 10 Gb copper Ethernet provides relatively short connections to a ToR switch 120, and optical cabling provides relatively longer connections to core switch 130. Interconnect technologies include, but are not limited to, Intel® OmniPath™, TrueScale™, Ultra Path Interconnect (UPI) (formerly called QPI or KTI), STL, FibreChannel, Ethernet, FibreChannel over Ethernet (FCoE), InfiniBand, PCI, PCIe, or fiber optics. Some of these will be more suitable for certain deployments or functions than others.

Note that while high-end fabrics such as OmniPath™ are mentioned above as examples in interconnect technologies, more generally, fabric 170 may be any suitable interconnect or bus for a particular application. This could, in some cases, include legacy interconnects like local area networks (LANs), token ring networks, synchronous optical networks (SONET), asynchronous transfer mode (ATM) networks, wireless networks such as WiFi and Bluetooth, “plain old telephone system” (POTS) interconnects, or similar. It is also expressly anticipated that in the future, new network technologies will arise to supplement or replace some of those listed here, and any such future network topologies and technologies can be or form a part of fabric 170.

In some examples, a NIC (also known as a network adapter, a LAN adapter or a physical network interface, and by similar terms) is a computer hardware component that connects a computer to a computer network. Early network interface controllers were commonly implemented on expansion cards that plugged into a computer bus. A low cost and ubiquity of some technology standards such as the Ethernet standard means that most newer computers have a network interface built into the motherboard. Modern NICs offer advanced features such as interrupt and direct memory access (DMA) interfaces to host processors, support for multiple receive and transmit queues, partitioning into multiple logical interfaces, and on-controller network traffic processing such as a TCP offload engine.

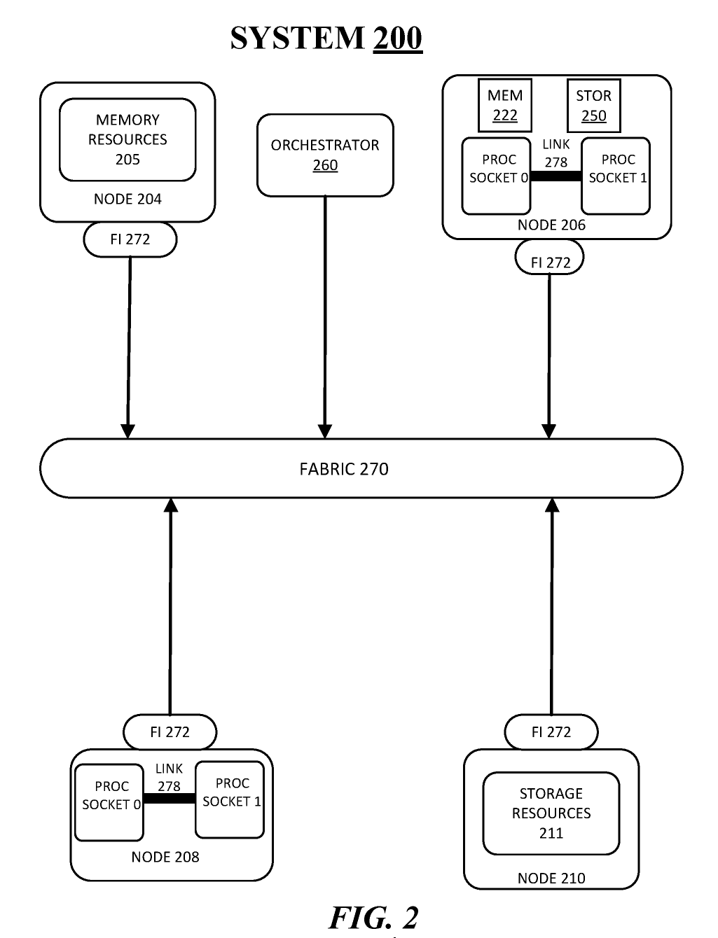

FIG. 2 illustrates an example system 200. In some examples, system 200 may be a data center similar, in various examples, to the data center mentioned above for system 100 shown in FIG. 1. Additional views are shown in FIG. 2 to illustrate different aspects of a data center.

System 200 may be controlled or managed by an orchestrator 260. Orchestrator 260 may manage or control, for example, software-defined networking (SDN), network function virtualization (NFV), virtual machine management, microservice orchestration, and similar services to elements of system 200. In some examples, Orchestrator 260 may be a standalone appliance with its own dedicated processor or processors, memory, storage, and fabric interface. In other examples, orchestrator 260 may itself be a virtual machine, container, microservice or function. Orchestrator 260 may have a global view of elements of system 200 and may have the ability to manage and configure multiple services or functions, such as dynamically allocating tenants, domains, services, service chains, virtual machines, virtual switches, and workload servers as necessary to meet current or anticipated workload demands associated with providing services or functions.

According to some examples, a fabric 270 may be configured to interconnect or communicatively couple elements of system 200. Fabric 270, in some examples, may be a similar type of fabric compared to fabric 170 of FIG. 1, or may be a different type of fabric. As mentioned above for fabric 170, fabric 270 may be configured to operate according to any suitable interconnect technology. For example, fabric 270 may be configured to operate according to the Intel® OmniPath™ interconnect technology, examples are not limited to the Intel® OmniPath™ interconnect technology.

As shown in FIG. 1, in some examples, system 200 includes a number of logic elements or computing platforms separately forming a plurality of nodes 204, 206, 208, and 210 (nodes may also be referred to as platforms). For these examples, each node of system 100 may be supported by a physical server, a group of servers, or other hardware. Each node may include one or more servers arranged to support one or more virtual machines as appropriate to applications being executed or supported by a respective node or nodes.

In some examples, as shown in FIG. 2, node 208 may be configured as a processing node including a processor socket 0 and processor socket 1. Processor socket 0 and processor socket 1 may be arranged to receive various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon® or Xeon Phi® processors; and similar processors. Node 208 may be arranged to support network or workload functions by hosting a plurality of virtual machines or virtual appliances.

According to some examples, onboard or local communication between processor socket 0 and processor socket 1 may be provided by a link 278. Link 278 may provide a high speed, short-length interconnect or communication link between the two processor sockets, so that virtual machines supported by node 208 can communicate with one another via a link that has a large data capacity and a small latency (e.g., high data throughput). Although not shown in FIG. 2, virtual switch (vSwitch) may be provisioned on node 208 to facilitate high data throughput between VMs hosted by node 208 via link 278.

In some examples, as shown in FIG. 2, node 208 may couple to fabric 270 via a fabric interface (FI) 272. FI 272 may be similar to fabric interfaces mentioned above for coupling to fabric 170. For example, FI 272 may be an Intel® HFI arranged to operate according to the Intel® OmniPath™ interconnect technology. Communication and/or data routed from node 208 to fabric 270 through FI 272 may be tunneled, such as by providing UPI tunneling over OmniPath™.

According to some examples, a data center example of system 100 may provide many functions in a distributed fashion supported by multiple nodes coupled with fabric 270 that in previous generations may have been provided locally on a single node. This distributed fashion may cause a need for a highly capable FI 272 for nodes 204, 206, 208 or 210 to couple with fabric 270. For these examples, FI 272 may be arranged to operate at data speeds having a data throughput or bandwidth of multiple gigabits per second. In some cases, FI 272 may be tightly coupled with node 208 as well as tightly coupled with nodes 204, 206 or 210. For example, logic and/or features of FI 272 may be integrated directly with processors inserted in processor socket 0 or processor socket 1 and thus may be part of a system-on-a-chip (SOC) or a system-on-a-package (SOP). This type of tight integration may enable relatively high data throughput between FI 272 and processor sockets 0/1, without a need for intermediary bus devices, which may introduce additional latency and thus lower data throughput for data routed through FI 272 to fabric 270. However, this is not to imply that examples where FI 272 is provided over a traditional bus are to be excluded. Rather, it is expressly anticipated that in some examples, FI 272 may be provided on a bus, such as a PCIe bus, which is a serialized version of PCI that provides higher data throughputs than traditional PCI. Throughout system 200, various nodes may provide the same or different types of FI 272 as mentioned above for node 208, such as onboard fabric interfaces and plug-in fabric interfaces. It should also be noted that certain blocks in an SOC or SOP may be provided as intellectual property (IP) blocks that can be “dropped” into an integrated circuit as a modular unit of the SOC or SOP. Thus, FI 272 may in some cases be derived from one or more such IP blocks.

Note that in “the network is the device” fashion, node 208 may include limited or a low amount of onboard memory or storage capacity. Rather, node 208 may rely primarily on distributed functions or services supported or provided by other nodes. For example, node 204 may be arranged as a memory server and node 208 may be arranged as a networked storage server. For these examples, node 208 may include only sufficient local/onboard memory and storage capacity to startup processing/networking elements of node 208 in order to establish communication with fabric 270. This kind of distributed architecture may be possible because of the very high data speeds of contemporary data centers for processing nodes such as node 208 to access remote memory and/or storage maintained at other nodes and may be advantageous because there is no need to over-provision resources for a given node. Rather, a large pool of high-speed or specialized memory resources may be dynamically provisioned between any number of nodes, so that a node having provisioned memory resources has access to a large pool of memory resources, but those memory resources do not sit idle when the node does not need them.

In some examples, as mentioned briefly above, node 204 may be a memory server and node 210 may be a storage server. For these examples, node 204 and 210 may respectively provide or support the operational memory and storage needs of node 208. For example, node 204 may provide remote direct memory access (RDMA), whereby node 208 may access memory resources 205 of node 204 via fabric 270 in a direct memory access (DMA) fashion, similar to how it would access its own onboard or local memory. Memory resources 205 may include various types of volatile and/or non-volatile memory. Types of volatile memory may include, but are not limited to, random-access memory (RAM), Dynamic RAM (DRAM), double data rate synchronous dynamic RAM (DDR SDRAM), static random-access memory (SRAM), thyristor RAM (TRAM) or zero-capacitor RAM (ZRAM). Types of non-volatile memory may include, but are not limited to, non-volatile types of memory such as 3-D cross-point memory that may be byte or block addressable. Byte or block addressable non-volatile types of memory may also include, but are not limited to, memory that uses chalcogenide phase change material (e.g., chalcogenide glass), multi-threshold level NAND flash memory, NOR flash memory, single or multi-level phase change memory (PCM), resistive memory, nanowire memory, ferroelectric transistor random access memory (FeTRAM), magnetoresistive random access memory (MRAM) that incorporates memristor technology, spin transfer torque MRAM (STT-MRAM), or a combination of any of the above, or other non-volatile memory types.

According to some examples, rather than having onboard or local storage (e.g., a hard or solid disk drive), node 208 may utilize storage resources 211 of node 210. Storage resources 211 may include, but are not limited to, a networked bunch of disks (NBOD), PCIe flash modules (PFM), redundant array of independent disks (RAID), redundant array of independent nodes (RAIN), network attached storage (NAS) or optical storage, tape drives. In some examples, in performing its designated function, node 208 may access memory resources 205 at node 204 and store results at storage resources 211.

In some examples, as shown in FIG. 2, node 206 also includes an FI 272, along with two processor sockets internally connected via a link 278. However, unlike node 208, node 3 206 includes its own onboard or local memory 222 and storage 250. Thus, node 206 may be configured to perform several functions primarily onboard or locally and may not need to rely upon memory/storage resources at nodes 204/210 compared to nodes 208's reliance on the memory/storage resources at these nodes. However, in some circumstances, node 206 may supplement or augment its own memory 222 and storage 250 with the distributed memory/resources at nodes 204/210 similar to node 208.

According to some examples, basic building block of the various components disclosed herein may be referred to as “logic”. Logic may include hardware (including, for example, a software-programmable processor, an application specific integrated circuit (ASIC), or a field programmable gate array (FPGA), configurable logic, external hardware (digital, analog, or mixed-signal), software, reciprocating software, services, drivers, interfaces, components, modules, algorithms, sensors, components, firmware, microcode, programmable logic, or objects that can coordinate to achieve a logical operation. Also, some types of logic may be provided by a tangible, non-transitory computer-readable medium having stored thereon executable instructions for instructing a processor to perform a certain task. Such a non-transitory medium could include, for example, a hard disk, solid state memory or disk, read-only memory (ROM), persistent memory, external storage, RAID, RAIN, NAS, optical storage, tape drive, backup system, cloud storage, or any combination of the foregoing by way of nonlimiting example. Such a medium could also include instructions programmed into an FPGA, configurable logic or encoded in hardware on an ASIC or processor.

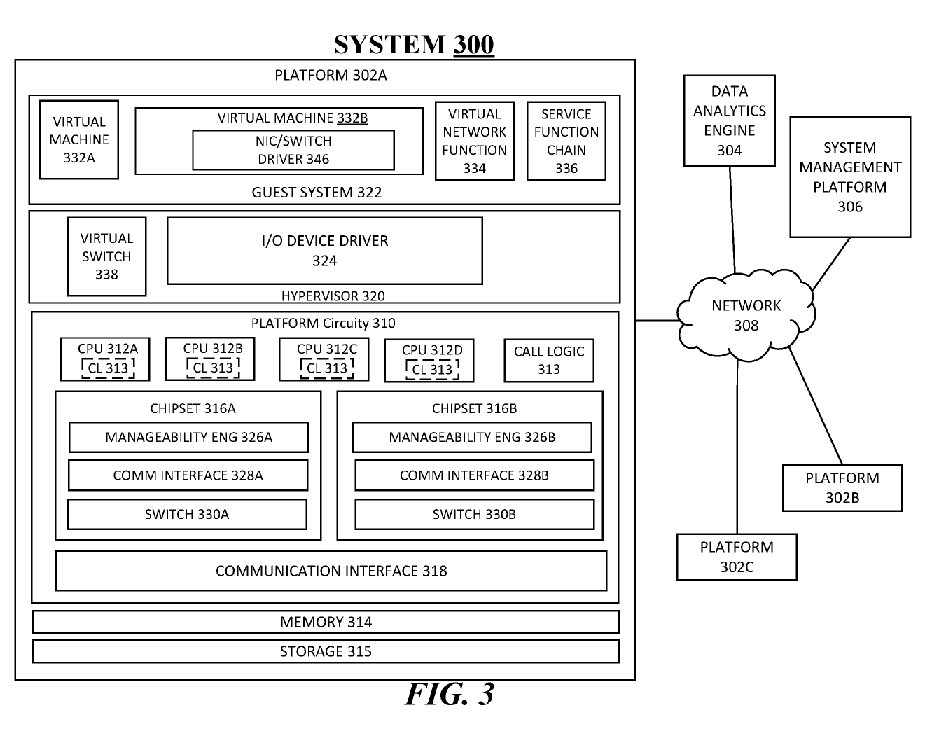

FIG. 3 illustrates an example system 300. In some examples, as shown in FIG. 3, system 300 includes a platform 302A. For these examples, platform 302A is depicted as a block diagram of various components or elements according to one or more examples of the present disclosure. In some examples, the term “platform” and “node” may be interchangeable. Also shown in FIG. 3, platforms 302B, and 302C, along with a system management platform 306 and data analytics engine 304 are interconnected or coupled via network 308. In other examples, a system such as system 300 may include any suitable number of (i.e., one or more) platforms.

In some examples, (e.g., when a system only includes a single platform), all or a portion of system management platform 306 may be included on a platform 302. A platform 302 may include platform circuitry 310 having processing units (CPUs) 312, a CALL logic 313, chipsets 316, a communication interface 318, and any other suitable hardware and/or software to execute a hypervisor 320 or other operating system capable of executing workloads associated with applications running on or supported by platform 302 such as but not limited to a memory 314 or a storage 315. According to some examples, a platform 302 may be arranged to serve as a host platform for one or more guest systems 322 that invoke these applications. The applications for example, may be part of or associated with providing a microservice in a cloud environment.

According to some examples, platform 302A may support various computing environments, such as high performance computing, a data center, a communications service provider infrastructure (e.g., one or more portions of an Evolved Packet Core), in-memory computing, a computing system of a vehicle (e.g., an automobile or airplane), Internet of Things, an industrial control system, other computing environment, or combination thereof.

In some examples, each platform 302 may include platform circuitry 310. Platform circuitry 310 may include, among other circuitry and/or logic enabling the functionality of platform 302, one or more CPUs 312, CALL logic 313, one or more chipsets 316, and communication interfaces 328. Although three platforms are illustrated, platform 302A may be interconnected or coupled with any number of platforms through network 308 or through another network (not shown). In various examples, a platform 302 may reside on a circuit board that is installed in a chassis, rack, or other structure that may include multiple platforms coupled together through network 308 (e.g., via a rack or backplane switch).

CPUs 312 may each include any number of processor cores and supporting circuitry or logic (e.g., uncores). The cores may be coupled to each other, to CALL logic 313, or implement CALL logic 313 as part of themselves, memory 314, to storage 315, to at least one chipset 316, and/or to a communication interface 318, through one or more controllers and/or interfaces residing on CPU 312 and/or chipset 316. For example, a CPU 312 is embodied within a socket that is permanently or removably coupled to platform 302A. Although four CPUs are shown, a platform 302 may include any number of CPUs.

CALL logic 313, as described in more detail below, may be configured to implement or support a special microcode instruction for providing a generic mechanism for function to function or function to infrastructure calls. The special microcode instruction, also described in more detail below, may be referred to as a CALLURI instruction. The functions may be implemented in software and running in virtual machines, bare metal, containers or as FaaS functions, or be a hardware functions implemented by just hardware logic, or combination of hardware and firmware. For example, between a first application executed on first VM(s) to provide a first virtual function hosted by platform 302A and a second application executed on second VM(s) to provide a second virtual function hosted by platform 302A. These function to function or function to infrastructure calls may also be made remotely. For example, between an application executed on VM(s) hosted by platform 302A to provide a first function and an application executed on VM(s) hosted by another platform 302 to provide a second function.

In some examples, CALL logic 313 may be either separate logic embodied in microcode instructions executed by one or more CPUs 312 or part of an FPGA, a configurable logic or an ASIC located on a same die or package as CPUs 312. In examples where CALL logic 313 is executed by one or more CPUs 312, CALL logic 313 may couple to memory 314 or storage 315 through an interface (e.g., a memory controller interface) at the one or more CPUs 312. In examples where CALL logic 313 is part of an FPGA, a configurable logic or an ASIC, CALL logic 313 may couple to memory 314 or storage 315 through an interface at the FPGA, the configurable logic or the ASIC.

Memory 314 may include any type of volatile or nonvolatile memory. Types of volatile memory may include, but are not limited to, (RAM), Dynamic RAM DRAM, DDR SDRAM, SRAM, TRAM or ZRAM. Types of non-volatile memory may include, but are not limited to, non-volatile types of memory such as 3-D cross-point memory that may be byte or block addressable. Byte or block addressable non-volatile types of memory may also include, but are not limited to, memory that uses chalcogenide phase change material (e.g., chalcogenide glass), multi-threshold level NAND flash memory, NOR flash memory, single or multi-level PCM, resistive memory, nanowire memory, FeTRAM, magnetoresistive random access memory MRAIVI that incorporates memristor technology, STT-MRAM, or a combination of any of the above, or other non-volatile memory types.

Storage 315 may include, but is not limited to, magnetic media (e.g., one or more tape drives), optical media, removable media, or any other suitable local or remote memory component or components. Storage 315 may be used for short, medium, and/or long term storage by platform 302A. In some examples, storage 315 may store any suitable data or information utilized by platform circuitry 310, including application software embedded or stored in a computer readable medium, and/or encoded logic incorporated in hardware or otherwise stored (e.g., firmware). Storage 315 may store data that may be accessed and used by cores of CPUs 312. In some examples, storage 315 may also provide storage for instructions that may be executed by the cores of CPUs 312 or other processing elements (e.g., logic resident on chipsets 316) to provide functionality associated with the manageability engine 326 or other components of platform circuitry 310 (e.g., CALL logic 313).

In some examples, a platform 302 may also include one or more chipsets 316 that may include circuitry or logic to support the operation of the CPUs 312. In various examples, chipset 316 may reside on the same die or package as a CPU 312 or on one or more different dies or packages. Each chipset may support any number of CPUs 312. A chipset 316 may also include one or more controllers to couple other components of platform circuitry 310 (e.g., communication interface 318, CALL logic 313, memory 314 or storage 315) to one or more CPUs. In the example depicted, each chipset 316 also includes a manageability engine 326. Manageability engine 326 may include logic or circuitry to support the operation of chipset 316.

In some examples, as shown in FIG. 3, chipsets 316 may also each include a communication interface 328. Communication interface 328 may be used for the communication of signaling and/or data between chipset 316 and one or more I/O devices, one or more networks 308, and/or one or more devices coupled to network 308 (e.g., system management platform 306). For example, communication interface 328 may be used to send and receive network traffic such as data packets. In one example, a communication interface 328 comprises one or more physical network interface controllers (NICs), also known as network interface cards or network adapters. A NIC may include electronic circuitry to communicate using any suitable physical layer and data link layer standard such as Ethernet (e.g., as defined by an IEEE 802.3 standard), Fibre Channel, InfiniBand, Wi-Fi, or other suitable standard. A NIC may include one or more physical ports that may couple to a cable (e.g., an Ethernet cable). A NIC may enable communication between any suitable element of chipset 316 (e.g., manageability engine 326 or switch 330) and another device coupled to network 308. In various examples, a NIC may be integrated with the chipset (i.e., may be on the same integrated circuit or circuit board as the rest of the chipset logic) or may be on a different integrated circuit or circuit board that is electromechanically coupled to the chipset.

According to some examples, communication interfaces 328 may allow communication of data (e.g., between the manageability engine 326 and the data center management platform 306) associated with management functions performed by manageability engine 326.

In some examples, switches 330 may couple to various ports (e.g., provided by NICs) of communication interface 328 and may switch data between these ports and various components of chipset 316 (e.g., one or more Peripheral Component Interconnect Express (PCIe) lanes coupled to CPUs 312). Switches 330 may be a physical or virtual (i.e., software) switch.

According to some examples, platform circuitry 310 may include an additional communication interface 318. Similar to communication interfaces 328, communication interfaces 318 may be used for the communication of signaling and/or data between platform circuitry 310 and one or more networks 308 and one or more devices coupled to the network 308. For example, communication interface 318 may be used to send and receive network traffic such as data packets. In one example, communication interfaces 318 may include one or more physical NICs. These NICs may enable communication between any suitable element of platform circuitry 310 (e.g., CPUs 312, or memory 314) and another device coupled to network 308 (e.g., elements of other platforms or remote computing devices coupled to network 308 through one or more networks).

Platform circuitry 310 may receive and perform any suitable types of workloads. A workload may include any request to utilize one or more resources of platform circuitry 310, such as one or more cores or associated processing resources. For example, a workload request may include a request to instantiate a software component, of platform 302A such as an I/O device driver 324 or guest system 322; a request to process a network packet received from a virtual machine 332 or device external to platform 302A (such as a network node coupled to network 308); a request to execute a process or thread associated with a guest system 322, an application running on platform 302A, a hypervisor 320 or other operating system running on platform 302A; or other suitable request.

A virtual machine 332 may emulate a computer system with its own dedicated hardware. A virtual machine 332 may run a guest operating system on top of the hypervisor 320. At least some components of platform 302A (e.g., CPUs 312, memory 314, storage 315, chipset 316 or communication interface 318) may be virtualized such that it appears to the guest operating system that the virtual machine 332 has its own dedicated hardware components.

A virtual machine 332 may include a virtualized NIC (vNIC), which is used by the virtual machine as its network interface. A vNIC may be assigned a media access control (MAC) address or other identifier, thus allowing multiple virtual machines 332 to be individually addressable in a network, both locally and remotely.

VNF 334 may include a software implementation of a functional building block with defined interfaces and behavior that can be deployed in a virtualized infrastructure. In some examples, a VNF 334 may include applications executed by one or more virtual machines 332 that collectively provide a specific virtual function (e.g., wide area network (WAN) optimization, virtual private network (VPN) termination, firewall operations, load-balancing operations, security functions, etc.). A VNF 334 supported by platform circuitry 310, memory 314 or storage 315 may provide the same functionality as traditional network components implemented through dedicated hardware. For example, VNF 334 may perform any suitable NFV workloads, such as virtualized evolved packet core (vEPC) workloads, mobility management entity workloads, 3rd Generation Partnership Project (3GPP) control and data plane workloads, etc.

Service function chain (SFC) 336 may be a group of VNFs 334 organized as a chain to perform a series of operations, such as network packet processing operations. Service function chaining may provide an ability to define an ordered list of network functions or services (e.g. firewalls, load balancers) that may be stitched or chained together to create a service chain.

A hypervisor 320 (also known as a virtual machine monitor) may comprise logic and/or features to create and run guest systems 322. Hypervisor 320 may present guest operating systems run by virtual machines with a virtual operating platform (i.e., it appears to the virtual machines that they are running on separate physical nodes when they are actually consolidated onto a single hardware platform) and manage the execution of the guest operating systems by platform circuitry 310. Services of hypervisor 320 may be provided by virtualizing in software or through hardware assisted resources that require minimal software intervention, or both. Multiple instances of a variety of guest operating systems may be managed by the hypervisor 320. Each platform 302 may have a separate instantiation of a hypervisor 320.

Hypervisor 320 may be a native or bare-metal hypervisor that runs directly on platform circuitry 310 to control the platform logic and manage the guest operating systems. Alternatively, hypervisor 320 may be a hosted hypervisor that runs on a host operating system and abstracts the guest operating systems from the host operating system. Hypervisor 320 may include a virtual switch 338 that may provide virtual switching and/or routing functions to virtual machines of guest systems 322. The virtual switch 338 may comprise a logical switching fabric that couples the vNICs of the virtual machines 332 to each other, thus creating a virtual network through which virtual machines may communicate with each other.

Virtual switch 338 may comprise a software element that is executed using components of platform circuitry 310. In various embodiments, hypervisor 320 may be in communication with any suitable entity (e.g., a SDN controller) which may cause hypervisor 320 to reconfigure the parameters of virtual switch 338 in response to changing conditions in platform 302 (e.g., the addition or deletion of virtual machines 332 or identification of optimizations that may be made to enhance performance of the platform).

The elements of platform circuitry 310 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g. cache coherent) bus, a layered protocol architecture, a differential bus, or a Gunning transceiver logic (GTL) bus.

Elements of the system 300 may be coupled together in any suitable manner such as through one or more networks 308. A network 308 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices.

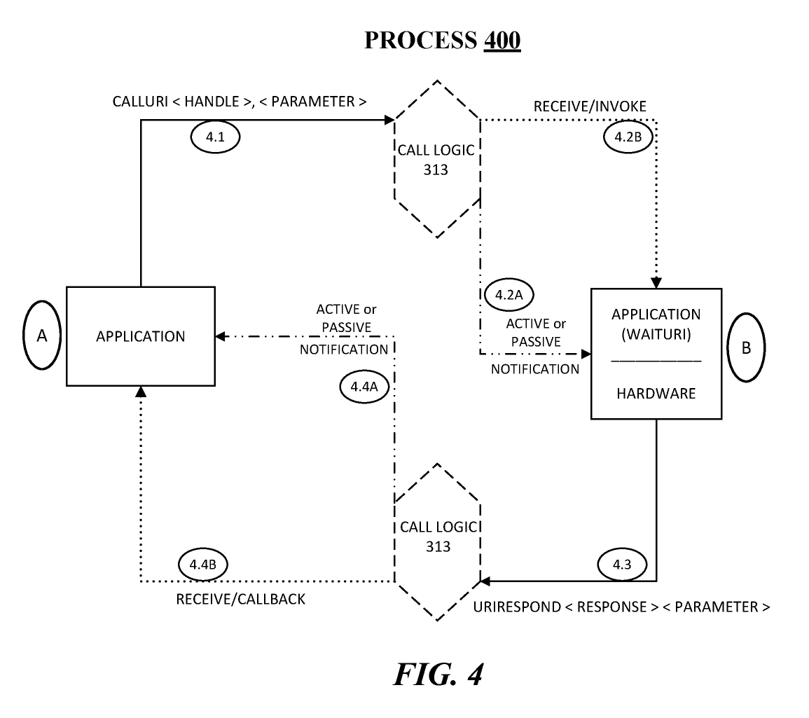

FIG. 4 illustrates an example process 400. In some examples, process 400 may represent a high level invocation of a function or a service. For these examples, elements of system 300 as shown in FIG. 3, may be related to process 400. These elements of system 300 may include elements of platform 302A, network 308 or platforms 302B or 302C. However, example process 400 is not limited to implementations using elements of system 300 shown in FIG. 3.

Beginning at process 4.1, a special instruction or microcode may be issued by application A to invoke a virtual function provided by application/hardware B or invoke infrastructure provided by application/hardware B. According to some examples, application A may be executed by one or more virtual machines 332B to provide a first virtual network function such as virtual network function 334. Meanwhile, if application/hardware B is an application, the application may provide a separate virtual network function and may be executed by one or more other virtual machines that may also be hosted by platform 302A or may be hosted by platforms 302B or 302C. If application/hardware B is infrastructure, the infrastructure represented by hardware B may be an accelerator (e.g., an ASIC or an FPGA) available to application A to augment or enhance its ability to provide virtual network function 334. The accelerator may be hosted by platform 302A or by platforms 302B or 302C.

According to some examples, the special instruction or microcode issued by application A may be a CALLURI instruction to logic and/or features of platform circuitry 310 such as CALL logic 313. The CALLURI instruction may include a “handle” portion and a “parameter” portion. At a high level, the handle portion of a the CALLURI instruction includes uniform resource identifier (URI) information that may be used to identify software (if application/hardware B is an application) or hardware (if application/hardware B is infrastructure) endpoints. In other words, the URI information may be used to identify the software or hardware endpoint that application A wants to invoke or call as a resource to provide a function. As described more below, in addition to URI information, the handle portion of the CALLURI instruction may include additional structure to facilitate use of various lookup tables maintained or accessible to logic and/or features of CALL logic 313. In this regard, as described more below, the handle may be a variable (string or token) that can be translated using the various lookup tables.

In some examples, the parameter portion of the CALLURI instruction may be a non-pointer variable that describes various aspects associated with the call or invocation of application/hardware B. For example, the parameter portion may describe whether the call or invocation is asynchronous (application A will not wait for response) or synchronous (application A will wait for response), whether memory in which the handle portion of the CALLURI instruction may be passed in is to be deallocated by the calling context (application A) or deallocated by the called context (application/hardware B), or whether the call operation initiated by the CALLURI instruction needs to be ordered with respected to other call operations initiated by other CALLURI instructions.

According to some examples, the upper hexagon shown in FIG. 2 represents hardware or software channels (i.e., different layers of protocol stack). For these examples, most of the overhead needed for application A to invoke application/hardware B may happen at process 4.1 and this overhead may be reduced substantially via use of CALL logic 313 to implement a series of actions. As described in more detail below, the series of actions implemented by logic and/or features of CALL logic 313 may include, a) checking that operands indicated in the handle and parameter portions of the CALLURI instruction are valid and safe, b) looking up a memorized sequence of microcode according to the handle portion, c) perform the request, which consists primarily of guiding a request packet somewhere, and d) returning control to the instruction stream (e.g., next instruction after the CALLURI instruction) unless the parameter portion of the CALLURI instruction indicates it is a synchronous invocation; and in which case, to perform a jump to a designated (pre-programmed) instruction address where application A may wait, yield, spin, etc.

According to some examples, the implementation of the CALLURI instruction by logic and/or features of CALL logic 313 may allow for a unifying of invocation mechanism(s) for functions or services provided across software libraries, system calls to operating system, platform services, hardware accelerators, cloud services, etc. The implementation of the CALLURI instruction may also make the calling software (application A) agnostic of the callee's (application/hardware B) implementation details without breaking application programming interfaces/application binary interfaces (APIs/ABIs). For example, a fast path for specific rules for marshalling parameters included or associated with the CALLURI instruction, while bridging more comprehensive but infrequent actions into software or hardware engines separate from CALL logic 313. For example, with asynchronous calls, the common routing of indications (events/triggers/completions) and small payloads for processing between these entities may be completed by the logic and/or features of CALL logic 313 implementing the CALLURI instruction. More complex actions, if needed, between domains can be done through a seamless indirection to a “bottom half” in an operating system (OS) just as interrupt handlers do for device interrupts and interrupt service routines (ISRs).

In some examples, an advantage of the CALLURI instruction is that when implemented it does not impose any new requirements on software. One way to think about the implementation of the CALLURI instruction is that of a hardware mailbox into which the caller drops a compactly encoded work and then continues; the mailbox only accepts what is legitimate and well formed, and otherwise just sets an error flag that application A may check just like software does with any arithmetic instruction that sets a condition code in today's architectures; and in that case, application A can use the conventional RPC. Thus, implementation of the CALLURI instruction may provide a unified, extensible and replaceable mechanism for invoking heterogeneous functions both locally and remotely and on different privilege levels. For example, use of logic and/or features of CALL logic 313 to implement the CALLURI instruction (e.g., as a hardware offload for call invocation), the CALLURI instruction may be used by application A without any changes in application A was well as no changes to middleware associated with application A. Changes may be needed only by OS or other operating environment to configure appropriate descriptors that are included in the handle portion of the CALLURI instruction.

Logic and/or features of CALL logic 313 to implement the CALLURI instruction issued by application A goes beyond simple execution of a user supplied virtual function. In some examples, implementation of the CALLURI instruction may cause checks to operand validity and tunneling of the invocation of a virtual function or service provided by application/hardware B (through microcode conferred privilege to do so) into a queue at or near application/hardware B; and application/hardware B may be in kernel, in a different VM or a different process, etc. Thus, for these examples, implementation of the CALLURI instructions gives application A an ability to convey a validated request to application/hardware B with which application A may not have shared anything ahead of time.

Moving to process 4.2A, logic and/or features of call logic 313 may wait for an active or passive notification from application/hardware B. In some examples, an active notification may be based on a synchronous indication included in the parameter portion of the CALLURI instruction and a passive notification may be based on an asynchronous indication included in the parameter portion of the CALLURI instruction. For an active notification, application A may wait for a notification for application/hardware B that the call has been received and the virtual function or service is in the process of being invoked. For a passive notification, application A may continue with other activities and may then occasionally poll its allocated address space (e.g., maintained in memory 314) to determine if the call has been received and the virtual function or service is in the process of being invoked.

Moving to process 4.2B, in some examples, application/hardware B, when notified of a call from application A, may issue a CALLURI instruction to logic and/or features of platform circuitry at it's side of the call. For example, call logic 313 at the platform 302 of which hosts application/hardware. The CALLURI instruction, in some examples, includes a similar handle and parameter portion. Logic and/or features of the call logic 313 at the platform 302 may then take steps necessary to invoke the requested service or virtual function indicated in the call from application A. In examples, were application/hardware B are hosted by a same host (e.g., both hosted by platform 302A), call logic 313 may include logic and/or features to perform any DMA copying of operands and memory areas in memory 314 allocated to application A to memory areas in memory 314 allocated to application/hardware B in the background while invoking the requested service or virtual function.

According to some examples, if application/hardware B is an application, a WAITURI function may be implemented. For these examples, WAITURI may allow for an efficient bridging between the invocation of the virtual function or service going past a transport mechanism on application/hardware B's (the callee) side and dispatch of a hardware or software implementation on application A's (the caller) side. In an example for cases where a service or virtual function provided by application/hardware B runs on a dedicated core of a CPU or processor, upon execution of WAITURI, virtual core/context executing service is going to “sleep” state until actions associated with implementation of a CALLURI instruction at application/hardware B's side of the call wakes it.

Moving to process 4.3, a special instruction or microcode may be issued by application/hardware B to provide an indication of whether the call made by application A has invoked the requested virtual function or service. According to some examples, the special instruction or microcode issued by application/hardware B may be a URIRESPOND instruction. The implementation of the URIRESPOND instruction by logic and/or features of platform circuitry 310 at the platform hosting application/hardware B (e.g., logic and/or features of CALL logic 313) may result in generation of a “response” and “parameter” in a return payload. The response portion may include URI information to indicate the requested service or virtual function that has been invoked and the parameter may indicate any associated parameters for invocation of the service or virtual function.

The implementation of the URIRESPOND instruction depends on whether the CALLURI instruction issued by application A indicated that the call for invocation of the service or virtual function to application/hardware B was synchronous or asynchronous. In some examples, if the call was synchronous, two actions may need to be performed. The first action is related to data movement. If the call is indeed remote (across host boundaries), then a return payload for a response to the call is marshalled and transport of the payload is initiated towards application A. When the call is a process local system call (e.g., same host platform), the results need to be copied back from kernel to user space. In these cases, implementation of the URIRESPOND instruction may automate the packing of results similar to the packing of information for invoking the service or virtual function when implementing CALLURI instructions. When the callee is local to the caller's address space at user level, and therefore the original call just turns into a virtual function invocation through implementation of the CALLURI instruction, then implementation of the URIRESPOND instructions needs to do nothing special about the result payload. The second action is related to return of control. For this second action, at application/hardware B (callee), a return path is just a function return if the callee is running at user level. For example, if callee and caller are on same core, it can be equal to return (RET) FAR instruction. Otherwise, implementation of the URIRESPOND instruction merely needs to result in a return from an OS call and is therefore equivalent to a fast return from fast system call (SYSEXIT) instruction together with restoring of context if the callee is returning control to a dispatcher (a service listener, for example). If callee and caller are on different cores/sockets, an inter-processor interrupt (IPI) may be used to notify a waiting caller.

In some examples, if the call was asynchronous, once application/hardware B (callee) has received the invocation request and queued it up or scheduled for execution in the background, the callee may return through an intermediary layer (e.g., hypervisor 320 or guest system 322) a wait variable. The initiator (application A) may poll this wait variable for status and also use it for retrieving results. Also, the initiator may optionally come back and block on the same wait variable with a time out if it so chooses (e.g., if it has run out of work to do while waiting virtually). From the initiator's point of view the asynchronous call is complete at that point. When the execution at the callee completes its invocation of the service or virtual function and the result/response comes back, the intermediary may invoke a callback function on a worker thread in the initiator's address space (e.g., maintained in memory 314). That callback function may act like a continuation function. That callback function, and the response/result data that needs to be sent back can be seen as symmetric to implementation of CALLURI instructions, and this symmetrical behavior is provided through the implementation of the URIRESPOND instruction.

Moving to process 4.4A, this process is a mirror action of process 4.2A in that actions are taken by logic and/or features of call logic 313 based on whether a synchronous or asynchronous indication was included in the parameter portion of the CALLURI instruction issued by application A. If synchronous then active notification and application A may wait for a notification that response has been received from application/hardware B indicating whether or not the requested service or virtual function has been invoked. If asynchronous then passive notification and application A may continue with other activities and may then occasionally poll its allocated address space to determine if the requested service or virtual function has been invoked.

Moving to process 4.4B, application A may receive result information included in payloads generated by implementation of URIRESPOND at application/hardware B or results/response from application/hardware B may be indicated via a callback function on a worker thread in application A's address space. The callback into application A's address space may be performed on a preassigned alternate thread stack and have an implicit constraint that call back functions run to completion. Process 400 then comes to an end.

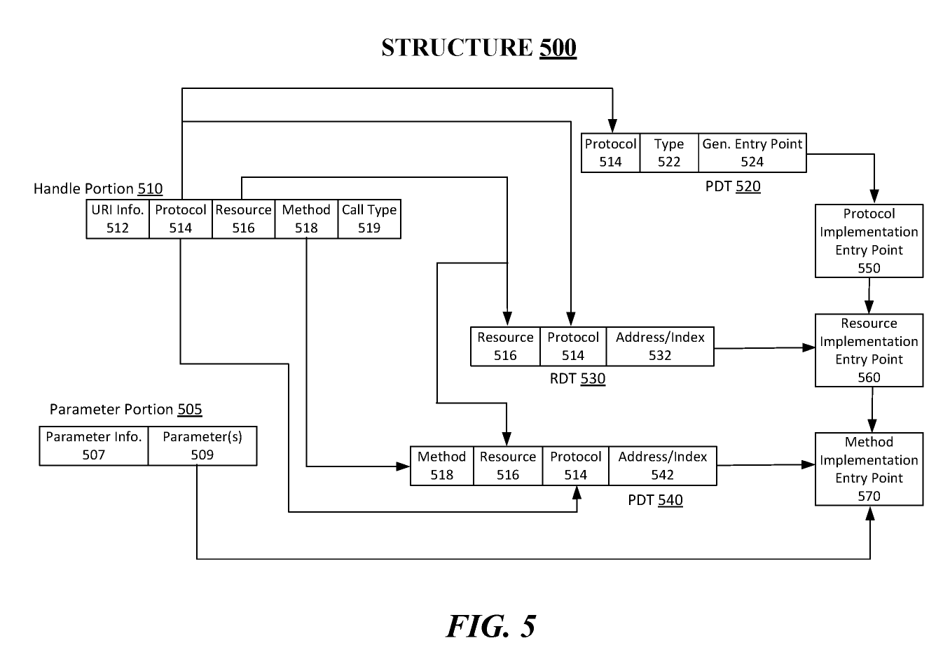

FIG. 5 illustrates an example structures 500 for use in invocation of a function or service. According to some examples, structures 500 may be associated with a CALLURI instruction that includes a handle portion and a parameter portion. For these examples, the handle portion may be depicted, as shown in FIG. 5, as a handle portion 510 and the parameter portion may be depicted as a parameter portion 505.

According to some examples, as shown in FIG. 5, handle portion 510 includes URI information 512, protocol 514, resource 516 method 518 and call type 519. For these examples, URI information 512 may include information to used to identify the software or hardware endpoint from which the CALLURI instruction was issued to invoke the virtual function or service. URI information 512 may also include information to indicate a size of the URI information. Protocol 514 may indicate a type of transport protocol to use to make the call to invoke the virtual function or service. For example, protocol 514 may indicate a protocol such as, but not limited to, hypertext transport protocol (HTTP) or other types of protocols. Resource 516 may indicate what type of resource is being called to invoke the virtual function or service (e.g., hardware, software, ASIC, FPGA, OS, VNF, VM, etc.). Method 518 may indicate what method will be used to make the call or invoke the virtual function or service. Call type 519 may indicate traits associated with the call. For example, whether the call is an expedited or a routine call or whether the call is a type of hybrid call that may be synchronous if it can be completed quickly, otherwise the hybrid call become asynchronous.

According to some examples, as shown in FIG. 5, parameter portion 505 includes parameter information 507 and parameter 509. For these examples, parameter information 507 may indicate a size (e.g., in bytes) of the parameters included in parameter portion 505. Parameters 509 may indicate whether the call or invocation associated with the CALLURI instruction is asynchronous or synchronous, whether memory in which handle portion 510 may be passed in is to be deallocated by the entity that caused the CALLURI instruction to be issued or deallocated by the called context, or whether the call operation initiated by the CALLURI instruction needs to be ordered with respected to other call operations initiated by other CALLURI instructions.

In some examples, information included in handle portion 510 and parameter portion 505 may be first be checked to whether the parameter or operands of the CALLURI instruction are valid and/or supported. If valid and/or supported, a longest match will be used to determine which of protocol descriptor table (PDT) 520, resource descriptor table (RDT) 530 or method descriptor table (MDT) 540 are used to determine an entry point for a call to invoke a virtual function or a service.

In some examples, if a longest match results in the information included in handle portion 510 pointing to PDT 520, then PDT 520 may include type 522 and generic entry point 524 information to determine a protocol implementation entry point 550. For these examples, type 522 indicates a method used to access it—whether it is a software or hardware implementation, which impacts on how to interpret entry point 524, and generic entry point 524 indicates generic methods for invocation of the function or service for protocol implementation entry point 550. PDT 520 may define a default endpoint/resource for specific protocols indicated in protocol 514. For example, if protocol 514 indicated HTTP, PDT 520 may refer to a service implemented by an OS as the default endpoint/resource.

According to some examples, if a longest match results in the information included in handle portion 510 pointing to RDT 530, then address/index 532 of RDT 530 may be used to determine a resource implementation entry point 560. The information in address/index 532 may point to information used to obtain instructions on how the type of resource indicated in resource 516 should be called using the protocol indicated in protocol 514.

In some examples, if a longest match results in the information included in handle portion 510 pointing to MDT 540, then address/index 542 of MDT 540 may be used to determine a method implementation entry point 570. The information in address/index 542 may point to information used to obtain instructions to implement a method indicated in method 518 using the protocol indicated in protocol 514 to call the type of resource indicated in resource 516.

According to some examples, a capability-based system for switching CALLURI descriptors on function calls that may result in minimal changes to existing solutions may be implemented. For these examples, even if a longest match results in the information included in handle portion 510 point to any two of PDT 520, RDT 530 or MDT 540, only a single table may be used to determine an entry point for a call invoked by a CALLURI instruction. Limiting to a single table may limit the invocation of the call based on capabilities of the application that issued the CALLURI instruction. For example, the application may not have adequate capabilities to implement instructions to implement a method and thus may limited to use of RDT 530 even if a longest match points to MDT 540.

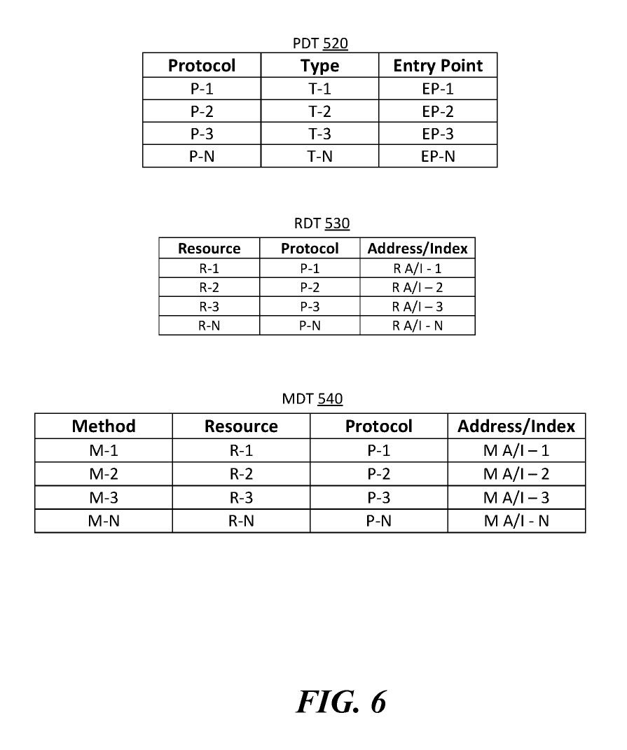

FIG. 6 illustrates example tables for invocation of a function or service. In some examples, as shown in FIG. 6, the example tables include PDT 520, RDT 530 and MDT 540. As mentioned previously for FIG. 5, PDT 520, RDT 530 or MDT 540 may be used to determine an entry point for a call to invoke a function or a service based on a longest match for information included in a handle portion of a CALLURI instruction. For these examples, logic and/or features of logic executed by platform circuitry of a platform hosting a calling application (e.g., call logic 313 of platform 302A) may utilize PDT 520, RDT 530 or MDT 540 based on the longest match.

In some examples, as shown in FIG. 6, PDT 520 may include table entries for protocols P-1 to P-N, T-1 to T-N or, or entry points EP-1 to EP-N, where “N” hereafter represents any positive whole integer >1. RDT 530 may include table entries for types of resources R-1 to R-N, protocols P-1 to P-N, or resource address/indexes RA/I-1 to RA/I-N for locating instructions on how respective resources R-1 to R-N are to be called using respective protocols P-1 to P-N. MDT 540 may include table entries for methods M-1 to M-N, resources R-1 to R-N, protocols P-1 to P-N, or method address/index MA/I-1 to MA/I-N for locating instructions on how methods M-1 to M-N, for respective resources R-1 to R-N are to be implemented when called using respective protocols P-1 to P-N. For these examples, RA/I-1 to RA/I-N or MA/I-1 to MA/I-N may include memory address pointers to locate respective instructions (e.g., pointers to a memory address for memory 135 hosted by platform 302A).

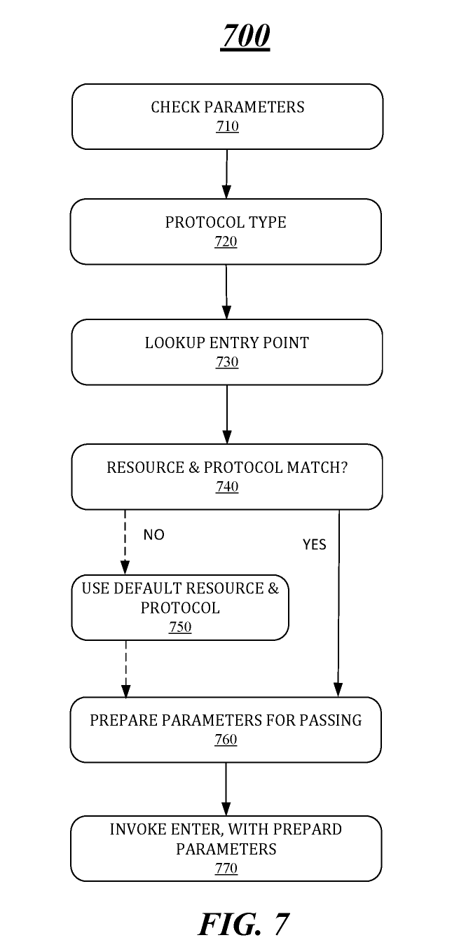

FIG. 7 illustrates an example logic flow 700 for invocation of a function or service. Logic flow 700 may be representative of at least some of the operations executed by logic and/or features executed by platform circuitry of a platform hosting a calling application such as CALL logic 313 of platform 302A. The actions may be responsive to CALL logic 313 processing a CALLURI instruction initiated by the calling application.

According to some examples, at block 710, CALL logic 313 may check parameter or operands of the CALLURI instruction to determine if they are valid. If not valid, CALL logic 313 may assert a flag to indicate that the call operation is not valid. The calling application, in some examples, may recognize the flag as indicating the CALLURI instruction included invalid information in the handle portion (e.g., information did not match a PDT, RDT or MDT) or invalid information in the parameter portion (e.g., parameter indicated was supported).

In some examples, at block 720, CALL logic 313 may use information in the handle portion of the CALLURI instruction to determine what protocol was indicated.

According to some examples, at block 730, CALL logic 313 may determine the entry point for the call operation based on a longest match of the handle portion compared to PDT, RDT or MDT.

In some examples, at block 740, CALL logic 313 may determine whether a resource indicated in the handle portion has a match to indicate what resource for the indicated protocol is to be used for the call operation. For these examples, information included in RDT 530 or MDT 540 may be used to make this determination.

According to some examples, at block 750, if a match was not found for the resource and the protocol indicated in the handle portion, CALL logic 313 uses a default resource with the indicated protocol for the call operation based on information included in PDT 520.

In some examples, at block 760, CALL logic 313 may prepare one or more parameters included in the parameter portion of the CALLURI instruction for passing or including in the call operation. For these examples, the parameters for the call operation may cross domains, and so any serialization, copying, etc. may be performed by CALL logic 313. In one example, this may be like pushing a call frame on a stack.

According to some examples, at block 770, CALL logic 313 may cause an invocation to be entered with the prepared parameters. For these examples, an invocation “ENTER” may be done—which may include logically enqueuing of the call request. If all is successful, a condition code indicates success and a completion handle is posted back for the CALLURI instructions that may come later, to use, if caller needs to harvest a result, e.g., if the call is non-synchronous. Otherwise, if the call is a synchronous call, logic flow 700 may end with a transfer of control to some software implementation of the waiting action (which may be a yield, a polling routine, etc.) that the calling application may have already pre-created and specified to hardware such as CALL logic 313.

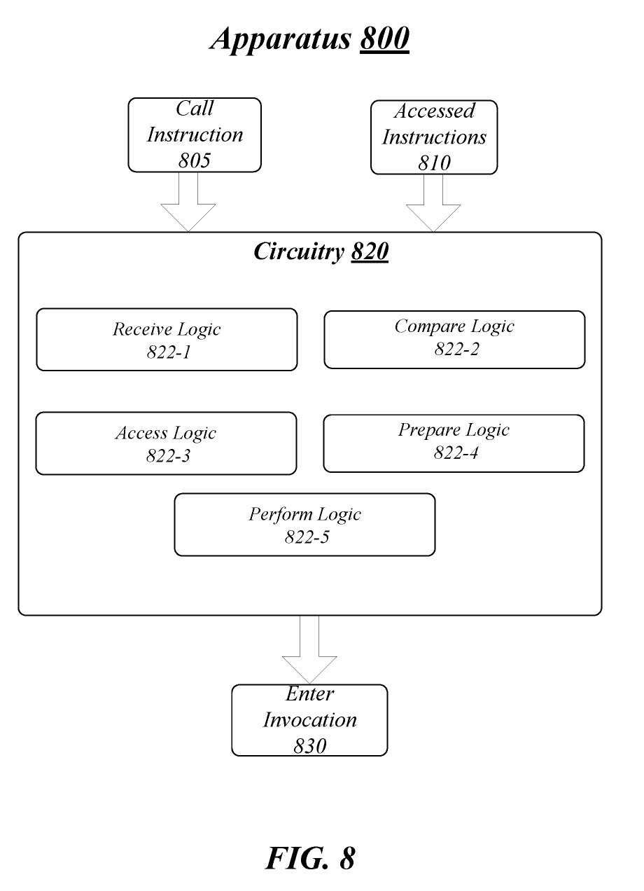

FIG. 8 illustrates an example block diagram for apparatus 800. Although apparatus 800 shown in FIG. 8 has a limited number of elements in a certain topology, it may be appreciated that the apparatus 800 may include more or less elements in alternate topologies as desired for a given implementation.

According to some examples, apparatus 800 may be supported by circuitry 820. For these examples, circuitry 820 may be at an ASIC, FPGA, processor, processor circuit, CPU, or core of a CPU for a platform, e.g., platform 302A shown in FIG. 3. For these examples, the ASIC, FPGA, processor, processor circuit, CPU, or one or more cores of a CPU may support logic and/or features of to receive and process a call instruction such as logic and/or features of CALL logic 113 shown and mentioned above for FIGS. 3-7. Circuitry 820 may be arranged to execute one or more software or firmware implemented modules, components or logic 822-a (module, component or logic may be used interchangeably in this context). It is worthy to note that “a” and “b” and “c” and similar designators as used herein are intended to be variables representing any positive integer. Thus, for example, if an implementation sets a value for a=5, then a complete set of software or firmware for modules, components or logic 822-a may include logic 822-1, 822-2, 822-3, 822-4 or 822-5. The examples presented are not limited in this context and the different variables used throughout may represent the same or different integer values. Also, “logic”, “module” or “component” may also include software/firmware stored in computer-readable media, and although types of logic are shown in FIG. 8 as discrete boxes, this does not limit these types of logic to storage in distinct computer-readable media components (e.g., a separate memory, etc.).

According to some examples, as mentioned above, circuitry 820 may include an ASIC, an FPGA, a configurable logic, a processor, a processor circuit, a CPU, or one or more cores of a CPU. Circuitry 820 may be generally arranged to execute one or more software components 822-a. Circuitry 820 may be all or at least a part of any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors.

According to some examples, apparatus 800 may include receive logic 822-1. Receive logic 822-1 may be executed by circuitry 820 to receive a call instruction from an application hosted by the platform that includes apparatus 800. For these examples, the call instruction may be to request invocation of a call for a virtual function provided by a different application. The call instruction may be included in call instruction 805.

In some examples, apparatus 800 may include a compare logic 822-2. Compare logic 822-2 may be executed by circuitry 820 to compare information included in the call instruction to one or more tables to determine whether the information matches information in at least one table of the one or more tables. For these examples, the information included in the call instruction may include a handle portion and a parameter portion (e.g., as described above for a CALLURI instruction in FIG. 5) and the one or more tables may be maintained by compare logic 822-2. The one or more tables, for examples, may a PDT table, an RDT table or an MDT table similar to PDT, RDT and MDT tables shown and mentioned above for FIGS. 5 and 6.

According to some examples, apparatus 800 may also include an access logic 822-3. Access logic 822-3 may be executed by circuitry 820 to access instructions maintained in a memory through an interface for apparatus 800 (not shown) based on the information matching information in the at least one table, the accessed instructions to indicate how to prepare the call to invoke the virtual function. For these examples, accessed instructions 810 may include the instructions accessed by access logic 822-3.

In some examples, apparatus 800 may also include a prepare logic 822-4. Prepare logic 822-4 may be executed by circuitry 820 to prepare one or more parameters for inclusion in the call based on parameter information included in the call instruction and based on the accessed instructions.

According to some examples, apparatus 800 may also include a perform logic 822-5. Perform logic 822-5 may be executed by circuitry 820 to perform the request by entering the invocation of the call with the one or more parameters to the different application. For these examples, enter invocation 830 may include the prepared one or more parameters.

Various components of apparatus 800 and a device or node implementing apparatus 800 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

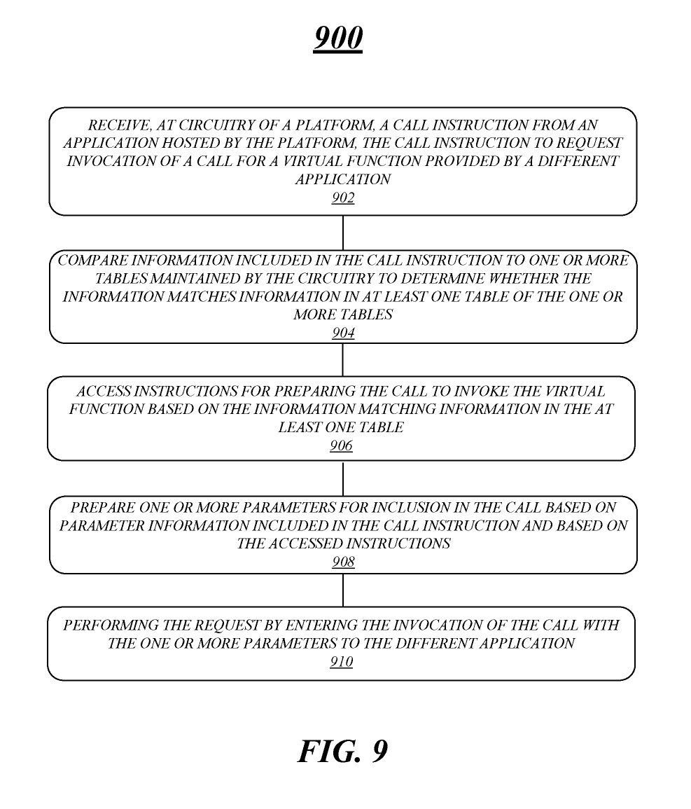

FIG. 9 illustrates an example logic flow 900. Logic flow 900 may be representative of some or all of the operations executed by one or more logic, features, or devices described herein, such as apparatus 900. More particularly, logic flow 900 may be implemented by at least receive logic 822-1, compare logic 822-2, access logic 822-3, prepare logic 822-4 or perform logic 822-5.

According to some examples, logic flow 900 at block 902 may receive, at circuitry of a platform, a call instruction from an application hosted by the platform, the call instruction to request invocation of a call for a virtual function provided by a different application. For these examples, receive logic 822-1 may receive the call instruction.

In some examples, logic flow 900 at block 904 may compare information included in the call instruction to one or more tables maintained by the circuitry to determine whether the information matches information in at least one table of the one or more tables. For these examples, compare logic 822-2 may compare the information.

According to some examples, logic flow 900 at block 906 may access instructions for preparing the call to invoke the virtual function based on the information matching information in the at least one table. For these examples, access logic 822-3 may access the instructions for preparing the call to invoke the virtual function.

In some examples, logic flow 900 at block 908 may prepare one or more parameters for inclusion in the call based on parameter information included in the call instruction and based on the accessed instructions. For these examples, prepare logic 822-4 may prepare the one or more parameter for inclusion.

According to some examples, logic flow 900 at block 910 may perform the request by entering the invocation of the call with the one or more parameters to the different application. For these examples, perform logic 822-5 may perform the request.

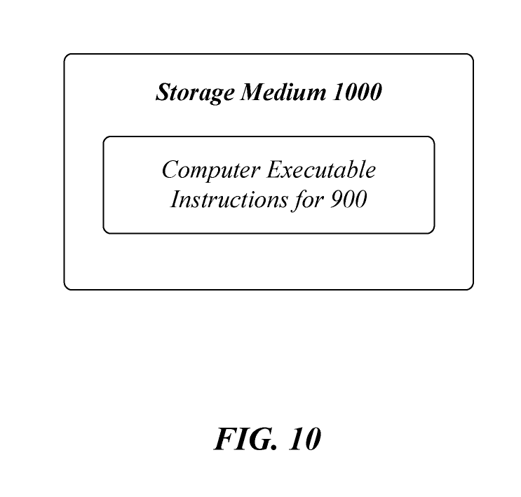

FIG. 10 illustrates an example storage medium 1000. As shown in FIG. 10, the first storage medium includes a storage medium 1000. The storage medium 1000 may comprise an article of manufacture. In some examples, storage medium 1000 may include any non-transitory computer readable medium or machine readable medium, such as an optical, magnetic or semiconductor storage. Storage medium 1000 may store various types of computer executable instructions, such as instructions to implement logic flow 900. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled” or “coupled with”, however, may also mean that two or more elements are not in direct contact with each other, but yet still co-operate or interact with each other.

The following examples pertain to additional examples of technologies disclosed herein.

### Example 1

An example apparatus may include an interface coupled with a memory maintained on a platform hosting an application and circuitry at the platform. The circuitry may be configurable logic. The circuity may execute logic to receive a call instruction from the application to request invocation of a call for a virtual function provided by a different application. The logic may also compare information included in the call instruction to one or more tables to determine whether the information matches information in at least one table of the one or more tables. The logic may also access instructions maintained in the memory through the interface based on the information matching information in the at least one table, the accessed instructions to indicate how to prepare the call to invoke the virtual function. The logic may also prepare one or more parameters for inclusion in the call based on parameter information included in the call instruction and based on the accessed instructions. The logic may also perform the request by entering the invocation of the call with the one or more parameters to the different application.

### Example 2

The apparatus of example 1, the different application may be hosted by the platform.

### Example 3

The apparatus of example 1, the different application may be hosted by a second platform. The second platform may be coupled with the platform via a network link.

### Example 4

The apparatus of example 1, the call for the virtual function may be a remote procedure call.

### Example 5

The apparatus of example 1, the information included in the call instruction may include a handle portion and a parameter portion.

### Example 6

The apparatus of example 5, the handle portion may include URI information to identify the different application and may also include at least one of protocol information, resource information or method information.

### Example 7

The apparatus of example 6, the logic to compare the protocol information, resource information or method information to the one or more tables may determine whether the information matches information in the at least one table.

### Example 8

The apparatus of example 7, the protocol information may match information in the at least one table. The protocol information may indicate a transport protocol to enter the invocation of the call with the one or more parameters to the different application.

### Example 9

The apparatus of example 7, the protocol information and the resource information may match information in the at least one table. The protocol information may indicate a transport protocol to enter the invocation of the call with the one or more parameters to the different application and the resource information may indicate a type of resource for the different application.

### Example 10

The apparatus of example 7, the protocol information, the resource information and the method information may match information in the at least one table. The protocol information may indicate a transport protocol to enter the invocation of the call with the one or more parameters to the different application. The resource information may indicate a type of resource for the different application and the method information may indicate a method to use the transport protocol to enter the invocation of the call to the type of resource indicated in the resource information.

### Example 11

The apparatus of example 7, the one or more tables may include at least two tables. For this example, the logic may select a single table from the at least two tables based on the protocol information. The resource information or the method information may match information in the at least two tables. The logic may select the single table to limit the invocation of the call for the virtual function based on capabilities of the application.

### Example 12

The apparatus of example 5, the parameter portion may include an indication of whether the call is a synchronous call or an asynchronous call.

### Example 13

The apparatus of example 1, the virtual function provided by the different application may be deep packet inspection, data encryption, data decryption, data compression, data decompression, internet protocol security or performance tracking.

### Example 14

The apparatus of example 1, the call instruction and the instructions accessed in the memory may be used for any types of cross-domain calls between the application and the different application to invoke the virtual function.

### Example 15

An example method may include receiving, at circuitry of a platform, a call instruction from an application hosted by the platform. The call instruction may request invocation of a call for a virtual function provided by a different application. The method may also include comparing information included in the call instruction to one or more tables maintained by the circuitry to determine whether the information matches information in at least one table of the one or more tables. The method may also include accessing instructions for preparing the call to invoke the virtual function based on the information matching information in the at least one table. The method may also include preparing one or more parameters for inclusion in the call based on parameter information included in the call instruction and based on the accessed instructions. The method may also include performing the request by entering the invocation of the call with the one or more parameters to the different application.

### Example 16

The method of example 15, the different application may be hosted by the platform.

### Example 17

The method of example 15, the different application may be hosted by a second platform, the second platform coupled with the platform via a network link.

### Example 18

The method of example 15, the call for the virtual function may be a remote procedure call.

### Example 19

The method of example 15, the information included in the call instruction may include a handle portion and a parameter portion.

### Example 20

The method of example 19, the handle portion may include URI information to identify the different application and may also include at least one of protocol information, resource information or method information.

### Example 21

The method of example 20 may also include comparing the protocol information, resource information or method information to the one or more tables maintained by the circuitry to determine whether the information matches information in the at least one table.

### Example 22

The method of example 21, the protocol information may match information in the at least one table. The protocol information may indicate a transport protocol to enter the invocation of the call with the one or more parameters to the different application.

### Example 23

The method of example 21, the protocol information and the resource information may match information in the at least one table. The protocol information may indicate a transport protocol to enter the invocation of the call with the one or more parameters to the different application and the resource information to indicate a type of resource for the different application.

### Example 24

The method of example 21, the protocol information, the resource information and the method information may match information in the at least one table. The protocol information may indicate a transport protocol to enter the invocation of the call with the one or more parameters to the different application. The resource information may indicate a type of resource for the different application and the method information to indicate a method to use the transport protocol to enter the invocation of the call to the type of resource indicated in the resource information.

### Example 25

The method of example 21, the one or more tables may include at least two tables. The method may also include selecting a single table from the at least two tables based on the protocol information, the resource information or the method information matching information in the at least two tables. The selecting of the single table to limit the invocation of the call for the virtual function based on capabilities of the application.

### Example 26

The method of example 19, the parameter portion may include an indication of whether the call is a synchronous call or an asynchronous call.

### Example 27

The method of example 15, the virtual function provided by the different application may be deep packet inspection, data encryption, data decryption, data compression, data decompression, internet protocol security or performance tracking.

### Example 28

The method of example 15, the call instruction and the instructions accessed in the memory may be used for any types of cross-domain calls between the application and the different application to invoke the virtual function.

### Example 29

An example at least one machine readable medium may include a plurality of instructions that in response to being executed by a system may cause the system to carry out a method according to any one of examples 15 to 28.

### Example 30

An example apparatus may include means for performing the methods of any one of examples 15 to 28.

### Example 31

At least one machine readable medium may include a plurality of instructions that in response to being executed by a system at a platform may cause the system to receive, at circuitry of the platform, a call instruction from an application hosted by the platform. The call instruction may request invocation of a call for a virtual function provided by a different application. The instructions may also cause the system to compare information included in the call instruction to one or more tables maintained by the circuitry to determine whether the information matches information in at least one table of the one or more tables. The instructions may also cause the system to access instructions for preparing the call to invoke the virtual function based on the information matching information in the at least one table. The instructions may also cause the system to prepare one or more parameters for inclusion in the call based on parameter information included in the call instruction and based on the accessed instructions. The instructions may also cause the system to perform the request by entering the invocation of the call with the one or more parameters to the different application.

### Example 32

The at least one machine readable medium of example 31, the different application may be hosted by the platform.

### Example 33

The at least one machine readable medium of example 31, the different application may be hosted by a second platform, the second platform coupled with the platform via a network link.

### Example 34

The at least one machine readable medium of example 31, the call for the virtual function may be a remote procedure call.

### Example 35

The at least one machine readable medium of example 31, the information included in the call instruction may include a handle portion and a parameter portion.

### Example 36

The at least one machine readable medium of example 35, the handle portion may include URI information to identify the different application and may also include at least one of protocol information, resource information or method information.

### Example 37

The at least one machine readable medium of example 36, the instructions may further cause the system to compare the protocol information, resource information or method information to the one or more tables maintained by the circuitry to determine whether the information matches information in the at least one table.

### Example 38

The at least one machine readable medium of example 37, the protocol information may match information in the at least one table. The protocol information may indicate a transport protocol to enter the invocation of the call with the one or more parameters to the different application.

### Example 39

The at least one machine readable medium of example 37, the protocol information and the resource information may match information in the at least one table. The protocol information may indicate a transport protocol to enter the invocation of the call with the one or more parameters to the different application and the resource information may indicate a type of resource for the different application.

### Example 40

The at least one machine readable medium of example 37, the protocol information, the resource information and the method information may match information in the at least one table. The protocol information may indicate a transport protocol to enter the invocation of the call with the one or more parameters to the different application. The resource information may indicate a type of resource for the different application. The method information may indicate a method to use the transport protocol to enter the invocation of the call to the type of resource indicated in the resource information.

### Example 41

The at least one machine readable medium of example 37, the one or more tables may include at least two tables. The instructions may further cause the system to select a single table from the at least two tables based on the protocol information. The resource information or the method information may match information in the at least two tables. The selection the single table to limit the invocation of the call for the virtual function based on capabilities of the application.

### Example 42

The at least one machine readable medium of example 35, the parameter portion may include an indication of whether the call is a synchronous call or an asynchronous call.

### Example 43

The at least one machine readable medium of example 31, the virtual function provided by the different application may be deep packet inspection, data encryption, data decryption, data compression, data decompression, internet protocol security or performance tracking.

### Example 44

The at least one machine readable medium of example 31, the call instruction and the instructions may be accessed in the memory are used for any types of cross-domain calls between the application and the different application to invoke the virtual function.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
an interface coupled with a memory maintained on a platform hosting an application; and
circuitry at the platform, the circuity to execute logic to:
receive a call instruction from the application to request invocation of a call for a virtual function provided by a different application;
compare information included in the call instruction to one or more tables to determine whether the information matches information in at least one table of the one or more tables;
access instructions maintained in the memory through the interface based on the information matching information in the at least one table, the accessed instructions to indicate how to prepare the call to invoke the virtual function;
prepare one or more parameters for inclusion in the call based on parameter information included in the call instruction and based on the accessed instructions; and
perform the request by entering the invocation of the call with the one or more parameters to the different application.

2. The apparatus of claim 1, comprising the different application hosted by the platform.

3. The apparatus of claim 1, comprising the different application hosted by a second platform, the second platform coupled with the platform via a network link.

4. The apparatus of claim 1, the call for the virtual function comprises a remote procedure call.

5. The apparatus of claim 1, comprising the information included in the call instruction includes a handle portion and a parameter portion.

6. The apparatus of claim 5, comprising the handle portion includes uniform resource identifier (URI) information to identify the different application and includes at least one of protocol information, resource information or method information.

7. The apparatus of claim 6, comprising the logic to compare the protocol information, resource information or method information to the one or more tables to determine whether the information matches information in the at least one table.

8. The apparatus of claim 7, comprising the protocol information matching information in the at least one table, the protocol information to indicate a transport protocol to enter the invocation of the call with the one or more parameters to the different application.

9. The apparatus of claim 7, comprising the protocol information and the resource information matching information in the at least one table, the protocol information to indicate a transport protocol to enter the invocation of the call with the one or more parameters to the different application and the resource information to indicate a type of resource for the different application.

10. The apparatus of claim 7, comprising the protocol information, the resource information and the method information matching information in the at least one table, the protocol information to indicate a transport protocol to enter the invocation of the call with the one or more parameters to the different application, the resource information to indicate a type of resource for the different application and the method information to indicate a method to use the transport protocol to enter the invocation of the call to the type of resource indicated in the resource information.

11. The apparatus of claim 7, comprising the one or more tables including at least two tables, the logic to select a single table from the at least two tables based on the protocol information, the resource information or the method information matching information in the at least two tables, the logic to select the single table to limit the invocation of the call for the virtual function based on capabilities of the application.

12. The apparatus of claim 5, comprising the parameter portion includes an indication of whether the call is a synchronous call or an asynchronous call.

13. The apparatus of claim 1, the virtual function provided by the different application comprises deep packet inspection, data encryption, data decryption, data compression, data decompression, internet protocol security or performance tracking.

14. The apparatus of claim 1, comprising the call instruction and the instructions accessed in the memory are used for any types of cross-domain calls between the application and the different application to invoke the virtual function.

15. The apparatus of claim 1, the circuitry comprising configurable logic.

16. A method comprising:
receiving, at circuitry of a platform, a call instruction from an application hosted by the platform, the call instruction to request invocation of a call for a virtual function provided by a different application;
comparing information included in the call instruction to one or more tables maintained by the circuitry to determine whether the information matches information in at least one table of the one or more tables;
accessing instructions for preparing the call to invoke the virtual function based on the information matching information in the at least one table;
preparing one or more parameters for inclusion in the call based on parameter information included in the call instruction and based on the accessed instructions; and
performing the request by entering the invocation of the call with the one or more parameters to the different application.

17. The method of claim 16, comprising the different application hosted by a second platform, the second platform coupled with the platform via a network link.

18. The method of claim 16, the call for the virtual function comprises a remote procedure call.

19. The method of claim 16, comprising the information included in the call instruction includes a handle portion and a parameter portion.

20. The method of claim 19, comprising the handle portion includes uniform resource identifier (URI) information to identify the different application and includes at least one of protocol information, resource information or method information.

21. The method of claim 20, comprising comparing the protocol information, resource information or method information to the one or more tables maintained by the circuitry to determine whether the information matches information in the at least one table.

22. The method of claim 21, comprising the protocol information matching information in the at least one table, the protocol information to indicate a transport protocol to enter the invocation of the call with the one or more parameters to the different application.

23. The method of claim 19, comprising the parameter portion includes an indication of whether the call is a synchronous call or an asynchronous call.

24. At least one machine readable medium comprising a plurality of instructions that in response to being executed by a system at a platform cause the system to:
receive, at circuitry of the platform, a call instruction from an application hosted by the platform, the call instruction to request invocation of a call for a virtual function provided by a different application;
compare information included in the call instruction to one or more tables maintained by the circuitry to determine whether the information matches information in at least one table of the one or more tables;
access instructions for preparing the call to invoke the virtual function based on the information matching information in the at least one table;
prepare one or more parameters for inclusion in the call based on parameter information included in the call instruction and based on the accessed instructions; and
perform the request by entering the invocation of the call with the one or more parameters to the different application.

25. The at least one machine readable medium of claim 24, comprising the different application hosted by the platform.

26. The at least one machine readable medium of claim 24, the call for the virtual function comprises a remote procedure call,

27. The at least one machine readable medium of claim 24, comprising the information included in the call instruction includes a handle portion and a parameter portion, the handle portion includes uniform resource identifier (URI) information to identify the different application and includes at least one of protocol information, resource information or method information, wherein the instruction to further cause the system to compare the protocol information, resource information or method information to the one or more tables maintained by the circuitry to determine whether the information matches information in the at least one table.

28. The at least one machine readable medium of claim 27, comprising the protocol information and the resource information matching information in the at least one table, the protocol information to indicate a transport protocol to enter the invocation of the call with the one or more parameters to the different application and the resource information to indicate a type of resource for the different application.

29. The at least one machine readable medium of claim 27, comprising the parameter portion includes an indication of whether the call is a synchronous call or an asynchronous call.
